(19) United States
(12) Patent Application Publication
(10) Pub. No.: US 2019/0122081 A1
(43) Pub. Date: Apr. 25, 2019

(54) CONFIDENT DEEP LEARNING ENSEMBLE METHOD AND APPARATUS BASED ON SPECIALIZATION

(71) Applicant: Korea Advanced Institute of Science and Technology, Daejeon (KR)

(72) Inventors: Jinwoo SHIN, Daejeon (KR); Kimin LEE, Daejeon (KR)

(21) Appl. No.: 15/798,237

(22) Filed: Oct. 30, 2017

(30) Foreign Application Priority Data
Oct. 19, 2017 (KR) 10-2017-0135635

(51) Int. Cl. G06K 9/62; G06N 3/08

(52) U.S. Cl. CPC G06K 9/6265; G06N 3/08

(57) ABSTRACT

Disclosed herein are a confident deep learning ensemble method and apparatus based on specialization. In one aspect, a confident deep learning ensemble method based on specialization proposed by the present invention includes the steps of generating a target function of maximizing entropy by minimizing Kullback-Leibler divergence with a uniform distribution with respect to the not-classified data of models for image processing and generating general features by sharing features between the models and performing learning for image processing using the general features.

### CROSS REFERENCE TO RELATED APPLICATION

The present application claims the benefit of Korean Patent Application No. 10-2017-0135635 filed in the Korean Intellectual Property Office on Oct. 19, 2017, the entire contents of which are incorporated herein by reference.

### BACKGROUND OF THE INVENTION

### 1. Technical Field

The present invention relates to an ensemble method and apparatus which can be applied to various situations, such as image classification and image segmentation.

### 2. Description of the Related Art

In the machine learning field, such as computer vision, voice recognition, natural language processing and signal processing, an ensemble scheme recently shows progressive performance. Although various ensemble schemes, such as boosting and bagging, are present, an independent ensemble (IE) scheme which learns each model independently and uses it is most universally used. The IE scheme has a limit to overall performance improvements because it is a scheme for improving performance by simply reducing a distribution of models.

In order to solve such a problem, an ensemble scheme specialized for specific data was proposed, but it is very difficult to actually apply the ensemble scheme due to an overconfident issue having high confidence although a deep learning model returns an erroneous solution. In other words, the ensemble scheme based on specialization has high performance for specialized data, but has a problem in that to select a model generating a correct solution is not clear due to the overconfident issue.

### SUMMARY OF THE INVENTION

An object of the present invention is to propose an ensemble scheme applicable to various situations, such as image classification and image segmentation, and to provide a method and apparatus for generating more general features and improving performance by sharing a new loss function for specializing each model for a specific sub-task while having high confidence and features between the models.

In one aspect, a confident deep learning ensemble method based on specialization proposed by the present invention includes the steps of generating a target function of maximizing entropy by minimizing Kullback-Leibler divergence with a uniform distribution with respect to the not-classified data of models for image processing and generating general features by sharing features between the models and performing learning for image processing using the general features.

The step of generating the target function of maximizing entropy by minimizing the Kullback-Leibler divergence with the uniform distribution with respect to the not-classified data of models for image processing includes learning an existing loss for corresponding data with respect to only one model having the highest accuracy and minimizing the Kullback-Leibler divergence with respect to remaining models.

The step of generating the target function of maximizing entropy by minimizing the Kullback-Leibler divergence with the uniform distribution with respect to the not-classified data of models for image processing includes the steps of selecting a random batch based on a stochastic gradient descent, calculating a target function value for each model with respect to the selected random batch, calculating a gradient for a learning loss with respect to a model having the smallest target function value for each datum and updating model parameters, and calculating a gradient for the Kullback-Leibler divergence with respect to the remaining models other than the model having the smallest target function value and updating the model parameters.

The step of calculating the target function value for each model with respect to the selected random batch includes calculating the target function value using an equation below.

$${L}_{C} ( 𝒟 ) = {min}_{{v}_{i}^{m}} {\sum }_{i = 1}^{N} {\sum }_{m = 1}^{M} ( {v}_{i}^{m} l ( {y}_{i} , {P}_{{θ}_{m}} ( y \vert {x}_{i} ) ) + β ( 1 - {v}_{i}^{m} ) {D}_{KL} ( u ( y ) \vert \vert {P}_{{θ}_{m}} ( y \vert {x}_{i} ) ) )$$

$$wherein$$

$${\sum }_{m = 1}^{M} {v}_{i}^{m} = 1$$

and vᵢ^{m}∈{0,1}, P_{θ}_{ₘ}(y|x) indicates a prediction value of an m-th model with respect to input x, D_{KL} indicates the Kullback-Leibler divergence, U(y) indicates the uniform distribution, β indicates a penalty parameter and vᵢ^{m} indicates an assignment parameter.

The step of generating the general features by sharing the feature between the models and performing the learning for image processing using the general features includes calculating the general features using an equation below.

$${h}_{m}^{l} ( x ) = φ ( {w}_{m}^{l} ( {h}_{m}^{l - 1} ( x ) + {\sum }_{n \neq m} {σ}_{nm}^{l} * {h}_{n}^{l - 1} ( x ) ) )$$

wherein W indicates weight of a neural network, h indicates a hidden feature, σ indicates a Bernoulli random feature, and ϕ indicates an activation function.

In yet another aspect, a confident deep learning ensemble apparatus based on specialization proposed by the present invention includes a target function calculation unit configured to calculate a target function of maximizing entropy by minimizing Kullback-Leibler divergence with a uniform distribution with respect to not-classified data of models for image processing and a feature sharing unit configured to generate general features by sharing features between the models and to perform learning for image processing using the general features.

The target function calculation unit learns an existing loss for corresponding data with respect to only one model having the highest accuracy and minimizes the Kullback-Leibler divergence with respect to the remaining models.

The target function calculation unit includes a random batch choice unit configured to select a random batch based on a stochastic gradient descent, a calculation unit configured to calculate a target function value for each model with respect to the selected random batch, and an update unit configured to calculate a gradient for a learning loss with respect to a model having the smallest target function value for each datum and update model parameters and to calculate a gradient for Kullback-Leibler divergence with respect to the remaining models other than the model having the smallest target function value and update model parameters.

### BRIEF DESCRIPTION OF THE DRAWINGS

FIG. 1 is a diagram for illustrating a deep learning ensemble according to an embodiment of the present invention.

FIG. 2 is a flowchart for illustrating a confident deep learning ensemble method based on specialization according to an embodiment of the present invention.

FIG. 3 is a diagram showing a data distribution for obtaining a target function according to an embodiment of the present invention.

FIG. 4 is a diagram for illustrating a process of calculating a target function value for each model according to an embodiment of the present invention.

FIG. 5 is a diagram for illustrating a process of computing update model parameters by calculating a gradient for a learning loss according to an embodiment of the present invention.

FIG. 6 is a diagram for illustrating the sharing of features between models according to an embodiment of the present invention.

FIG. 7 is a diagram showing the configuration of a confident deep learning ensemble apparatus based on specialization according to an embodiment of the present invention.

### DETAILED DESCRIPTION

Hereinafter, embodiments of the present invention are described in detail with reference to the accompanying drawings.

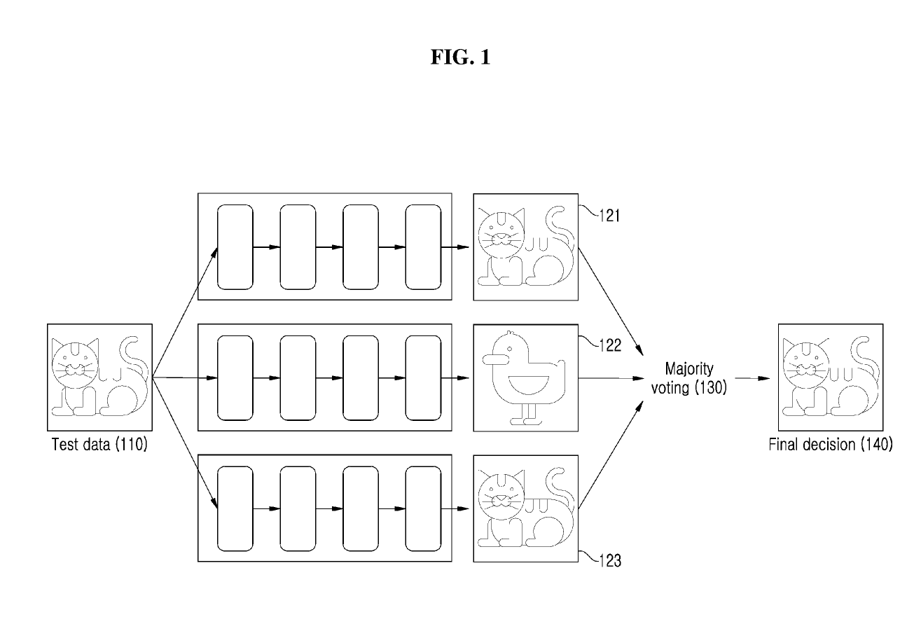

FIG. 1 is a diagram for illustrating a deep learning ensemble according to an embodiment of the present invention.

The deep learning ensemble combines outputs of train multiple models for a final decision using the train multiple models. For example, the deep learning ensemble generates train multiple models 121, 122 and 123 for test data 110 and makes a final decision 140 having majority voting 130 using the train multiple models.

Recently, in the machine learning field, such as computer vision, voice recognition, natural language processing and signal processing, an ensemble scheme shows progressive performance. Although various ensemble schemes, such as boosting and bagging, are present, an independent ensemble (IE) scheme which learns each model independently and uses it is most universally used. The IE scheme has a limit to overall performance improvements because it is a scheme for improving performance by simply reducing a distribution of models.

In order to solve such a problem, an ensemble scheme specialized for specific data was proposed, but it is very difficult to actually apply the ensemble scheme due to an overconfident issue having high confidence although a deep learning model returns an erroneous solution. In other words, the ensemble scheme based on specialization has high performance for specialized data, but has a problem in that to select a model generating a correct solution is not clear due to the overconfident issue.

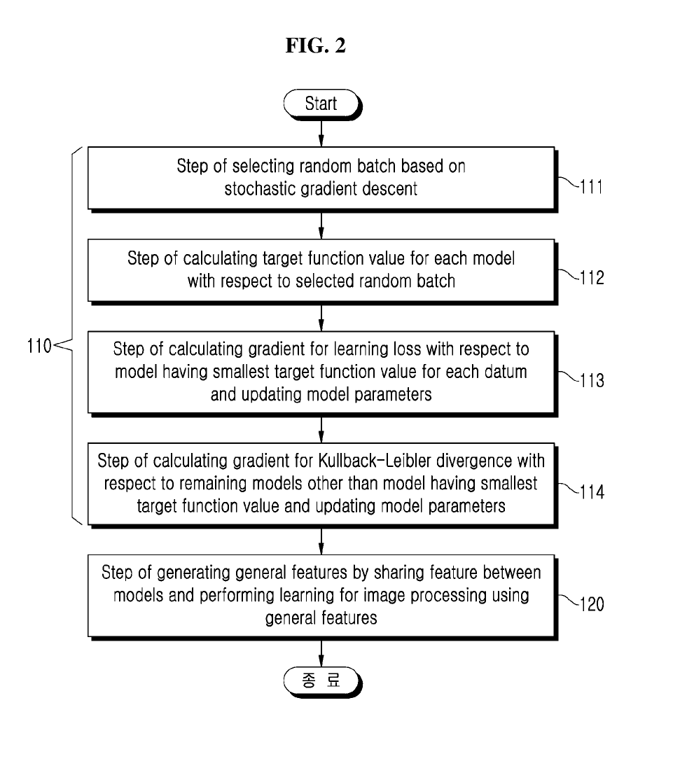

FIG. 2 is a flowchart for illustrating a confident deep learning ensemble method based on specialization according to an embodiment of the present invention.

An embodiment of the present invention relates to an ensemble scheme applicable to various situations, such as image classification and image segmentation, and to a scheme, which solves the aforementioned problems, and generates more general features and improves performance by sharing a new loss function for specializing each model for a specific sub-task while having high confidence and features between the models. A new ensemble scheme called confident multiple choice learning (CMCL) proposed by the present invention includes a confident oracle loss, that is, a new target function, and a feature sharing scheme.

In other words, the proposed confident deep learning ensemble method based on specialization includes the step 110 of generating a target function of maximizing entropy by minimizing Kullback-Leibler divergence with a uniform distribution with respect to the not-classified data of models for image processing and the step 120 of generating general features by sharing features between the models and performing learning for image processing using the general features.

In the step 110, the target function of maximizing entropy by minimizing Kullback-Leibler divergence with a uniform distribution with respect to the not-classified data of the models for image processing is generated. In this case, an existing loss for corresponding data is learnt with respect to only one model having the highest accuracy, and the Kullback-Leibler divergence is minimized with respect to the remaining models.

The step 110 of generating the target function of maximizing entropy by minimizing the Kullback-Leibler divergence with the uniform distribution with respect to the not-classified data of models for image processing includes the step 111 of selecting a random batch based on a stochastic gradient descent, the step 112 of calculating a target function value for each model with respect to the selected random batch, the step 113 of calculating a gradient for a learning loss with respect to a model having the smallest target function value for each datum and updating model parameters, and the step 114 of calculating a gradient for the Kullback-Leibler divergence with respect to the remaining models other than the model having the smallest target function value and updating model parameters.

In accordance with an embodiment of the present invention, in order for learning specialized for confident and specific data to be performed, the following target function is proposed.

$${L}_{C} ( 𝒟 ) = {min}_{{v}_{i}^{m}} {\sum }_{i = 1}^{N} {\sum }_{m = 1}^{M} ( {v}_{i}^{m} l ( {y}_{i} , {P}_{{θ}_{m}} ( y \vert {x}_{i} ) ) + β ( 1 - {v}_{i}^{m} ) {D}_{KL} ( u ( y ) \vert \vert {P}_{{θ}_{m}} ( y \vert {x}_{i} ) ) )$$

In this case,

$${\sum }_{m = 1}^{M} {v}_{i}^{m} = 1 ,$$

∀i, vᵢ^{m}∈{0,1}, and ∀i,m. P_{θ}_{ₘ}(y|x) is a prediction value of an m-th model with respect to input x, D_{KL} indicates Kullback-Leibler divergence, U(y) indicates a uniform distribution, β indicates a penalty parameter, and vᵢ^{m} indicates an assignment parameter.

It may be seen that unlike the target function of multiple choice learning (MCL), the new target function maximizes entropy by minimizing the Kullback-Leibler divergence with the uniform distribution for not-specialized data. For example, in the case of classification, it may be seen that only the most accurate model learns an existing loss for corresponding data and other models have a predictive value by minimizing the Kullback-Leibler divergence.

In order to optimize a confident oracle loss, the following algorithm based on a stochastic gradient descent is proposed.

```
Algorithm I Confident MCL (CMCL)
  Input: Dataset [symbol]  = {(xᵢ, yᵢ) | xᵢ ∈ χ, yᵢ ∈ y } and penalty parameter β
  Output: Ensemble of M trained models
  repeat
    Let [symbol]  (y) be a uniform distribution
    Sample random batch [symbol]  ⊂ [symbol]
    for m = 1 to M do
      Compute the loss of the m-th model:
      ${L}_{i}^{m} ← 𝓁 ( {y}_{i} , {P}_{{θ}_{m}} ( {y}_{i} \vert {x}_{i} ) ) + β {\sum }_{\hat{m} m} {D}_{KL} ( U ( y ) ‖ {P}_{{θ}_{\hat{m}}} ( y \vert {x}_{i} ) ) , ∀ ( {x}_{i} , {y}_{i} ) ∈ ℬ$
    end for
    for m = 1 to M do
      for i = 1 to | [symbol] | do
        if the m-th model has the lowest loss then
          Compute the gradient of the training loss l (yᵢ, P_{θ}_{ₘ} (yᵢ | xᵢ)) w.r.t θₘ
        else
          /* version 0: exact gradient */
          Compute the gradient of the KL divergence βD_{KL} (U (y) ∥ P_{θ}_{ₘ} (y | xᵢ)) w.r.t θₘ
        end if
      end for
      Update the model parameters
    end for
until convergence
```

The algorithm selects a random batch and calculates a target function value for each model with respect to the corresponding batch. Thereafter, a gradient for an existing learning loss is calculated and model parameters are updated with respect to only a model having the smallest target function value for each datum. A gradient for the Kullback-Leibler divergence is calculated and model parameters are updated with respect to other models.

In the step 120, the general features are generated by sharing the feature between the models, and learning for image processing is performed using the general features.

In order to further improve performance along with a confident oracle loss, there is proposed a normalization scheme called feature sharing. It may be seen that to extract general features from data is important in order to solve the overconfidence issue. Accordingly, there is proposed a feature sharing scheme for sharing a feature between ensemble models.

In accordance with an embodiment of the present invention, if M neural networks having an L layer are given, an equation for feature sharing is defined as follows.

$${h}_{m}^{l} ( x ) = φ ( {w}_{m}^{l} ( {h}_{m}^{l - 1} ( x ) + {\sum }_{n \neq m} {σ}_{nm}^{l} * {h}_{n}^{l - 1} ( x ) ) )$$

wherein W indicates weight of a neural network, h indicates a hidden feature, a indicates a Bernoulli random feature, and ϕ indicates an activation function.

As may be seen from the above equation, the feature of a specific model is defined by sharing the features of other models. In such a case, however, overfitting is prevented by multiplying the feature by a random mask like dropout because dependence between the models can be increased.

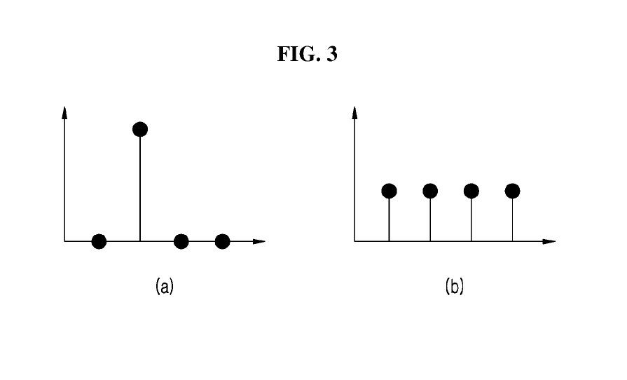

FIG. 3 is a diagram showing a data distribution for obtaining a target function according to an embodiment of the present invention.

FIG. 3(a) is a graph showing a data distribution, and FIG. 3(b) is a graph showing a uniform distribution. In this case, vᵢ=1 with respect to target data, and vᵢ=0 with respect to non-target data.

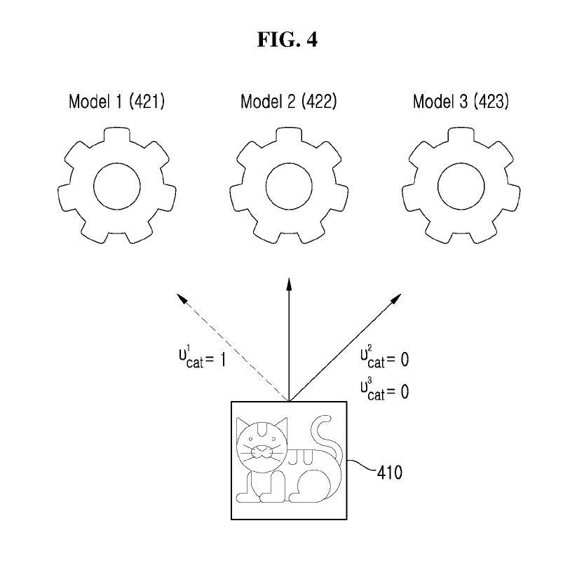

FIG. 4 is a diagram for illustrating a process of calculating a target function value for each model according to an embodiment of the present invention.

In order to calculate a target function of maximizing entropy by minimizing Kullback-Leibler divergence with a uniform distribution with respect to the not-classified data of models for image processing, first, a random batch is selected based on a stochastic gradient descent. For example, with respect to a selected corresponding batch 410, a target function value for each of a model 1 421, model 2 422 and model 3 423 is calculated. A gradient for a learning loss and model parameters are updated with respect to a model having the smallest target function value for each datum regarding each of the models. A gradient for Kullback-Leibler divergence is calculated and model parameters are updated with respect to the remaining models other than the model having the smallest target function value.

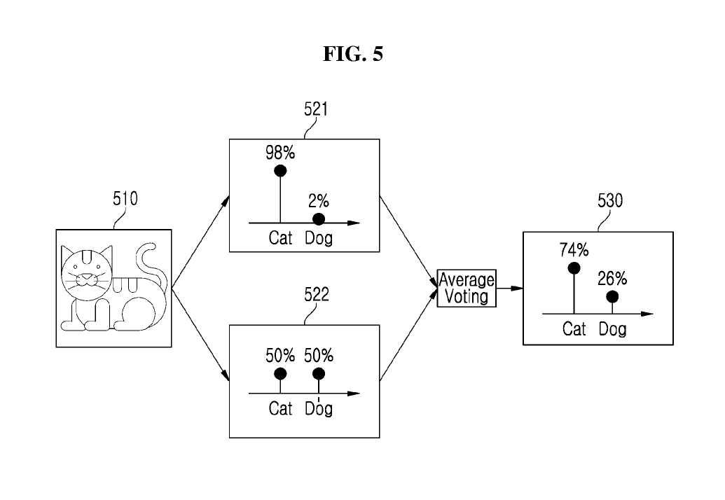

FIG. 5 is a diagram for illustrating a process of computing update model parameters by calculating a gradient for a learning loss according to an embodiment of the present invention.

As described above, with respect to a model 510 having the smallest target function value 510, a gradient for a learning loss is calculated and parameters are updated. First, a data distribution graph 521 and a uniform distribution graph 522 for the corresponding model 510 are calculated. A graph 530 representing normalized model parameters by Average Voting the graphs is calculated.

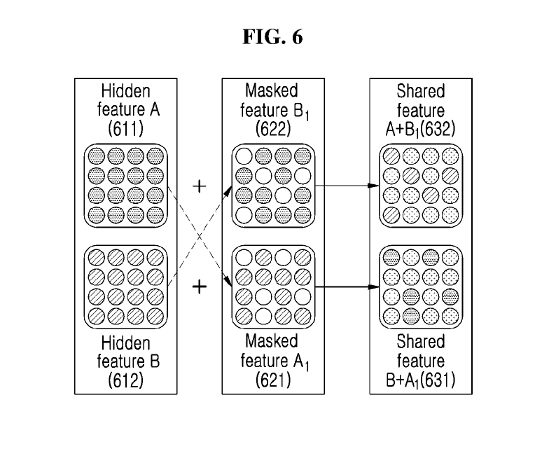

FIG. 6 is a diagram for illustrating the sharing of features between models according to an embodiment of the present invention.

There is proposed a normalization scheme called feature sharing in order to further improve performance along with a confident oracle loss. General features are generated by the sharing of features between models, and learning for image processing is performed using the general features. In order to solve the overconfidence issue, it is important to extract data from the general features. Accordingly, a feature between ensemble models according to an embodiment of the present invention is shared.

The feature of a specific model is defined by sharing the features of other models. In such a case, however, the feature is multiplied by a random mask like dropout in order to prevent overfitting because dependence between the models may be increased.

For example, as in FIG. 6, shared features A+B₁ 632 are generated by sharing hidden features A 611 and Vasded features B₁ 622, and shared features B+A₁ 631 are generated by sharing hidden features B 612 and Vasded features A₁ 621.

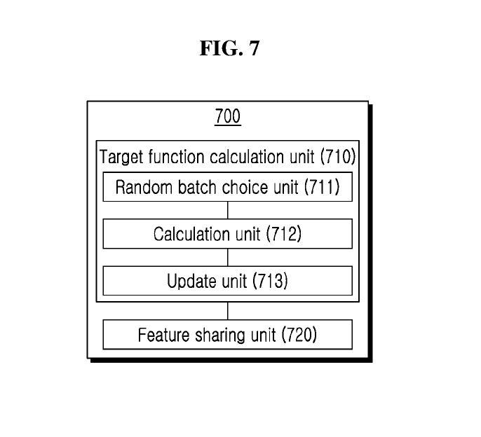

FIG. 7 is a diagram showing the configuration of a confident deep learning ensemble apparatus based on specialization according to an embodiment of the present invention.

An embodiment of the present invention relates to an ensemble scheme applicable to various situations, such as image classification and image segmentation, and to a scheme, which solves the aforementioned problems and generates further general features and improves performance by sharing a new loss function for specializing each model for a specific sub-task while having high confidence and feature between the models. A new ensemble scheme called confident multiple choice learning (CMCL), proposed by the present invention, includes a confident oracle loss, that is, a new target function, and a feature sharing scheme.

A proposed confident deep learning ensemble apparatus 700 based on specialization includes a target function calculation unit 710 configured to calculate a target function of maximizing entropy by minimizing Kullback-Leibler divergence with a uniform distribution with respect to not-classified data of models for image processing and a feature sharing unit 720 configured to generate general features by sharing features between the models and to perform learning for image processing using the general features.

The target function calculation unit 710 calculates a target function of maximizing entropy by minimizing Kullback-Leibler divergence with a uniform distribution with respect to not-classified data of models for image processing. In this case, the target function calculation unit 710 learns an existing loss for corresponding data with respect to only one model having the highest accuracy and minimizes the Kullback-Leibler divergence with respect to the remaining models.

The target function calculation unit 710 includes a random batch choice unit 711, a calculation unit 712 and an update unit 713.

The random batch choice unit 711 selects a random batch based on a stochastic gradient descent.

The calculation unit 712 calculates a target function value for each model with respect to the selected random batch.

The update unit 713 calculates a gradient for a learning loss with respect to a model having the smallest target function value for each datum and update model parameters, and calculates a gradient for the Kullback-Leibler divergence with respect to the remaining models other than the model having the smallest target function value and update model parameters.

In accordance with an embodiment of the present invention, in order for learning specialized for confident and specific data to be performed, the following target function is calculated using the calculation unit 712.

$${L}_{C} ( 𝒟 ) = {min}_{{v}_{i}^{m}} {\sum }_{i = 1}^{N} {\sum }_{m = 1}^{M} ( {v}_{i}^{m} l ( {y}_{i} , {P}_{{θ}_{m}} ( y \vert {x}_{i} ) ) + β ( 1 - {v}_{i}^{m} ) {D}_{KL} ( u ( y ) \vert \vert {P}_{{θ}_{m}} ( y \vert {x}_{i} ) ) )$$

In the case,

$${\sum }_{m = 1}^{M} {v}_{i}^{m} = 1 ,$$

∀i, vᵢ^{m}∈{0,1}, and ∀i,m. P_{θ}_{ₘ}(y|x) is a prediction value of an m-th model with respect to input x, D_{KL} indicates Kullback-Leibler divergence, U(y) indicates a uniform distribution, β indicates a penalty parameter, and vᵢ^{m} indicates an assignment parameter.

It may be seen that unlike the target function of multiple choice learning (MCL), the new target function maximizes entropy by minimizing the Kullback-Leibler divergence with the uniform distribution for not-specialized data. For example, in the case of classification, it may be seen that only the most accurate model learns an existing loss for corresponding data and other models have a predictive value by minimizing the Kullback-Leibler divergence.

In order to optimize a confident oracle loss, the following algorithm1 based on a stochastic gradient descent is proposed.

The algorithm selects a random batch and calculates a target function value for each model with respect to the corresponding batch. Thereafter, a gradient for an existing learning loss is calculated and model parameters are updated with respect to only a model having the smallest target function value for each datum. A gradient for the Kullback-Leibler divergence is calculated and model parameters are updated with respect to other models.

The feature sharing unit 720 generates general features by sharing features between models and performs learning for image processing using the general features.

In order to further improve performance along with a confident oracle loss, there is proposed a normalization scheme called feature sharing. It may be seen that to extract general features from data is important in order to solve the overconfidence issue. Accordingly, there is proposed a feature sharing scheme for sharing a feature between ensemble models.

In accordance with an embodiment of the present invention, if M neural networks having an L layer are given, an equation for feature sharing is defined as follows.

$${h}_{m}^{l} ( x ) = φ ( {w}_{m}^{l} ( {h}_{m}^{l - 1} ( x ) + {\sum }_{n \neq m} {σ}_{nm}^{l} * {h}_{n}^{l - 1} ( x ) ) )$$

wherein W indicates weight of a neural network, h indicates a hidden feature, σ indicates a Bernoulli random feature, and ϕ indicates an activation function.

As may be seen from the above equation, the feature of a specific model is defined by sharing the features of other models. In such a case, however, overfitting is prevented by multiplying the feature by a random mask like dropout because dependence between the models can be increased.

The proposed confident deep learning ensemble method and apparatus based on specialization use a scheme which is capable of generating general features and performing learning through the sharing of a new loss function for specializing each model for specific data while having high confidence and features between the models by improving an existing ensemble scheme in various situations, such as image classification and image segmentation.

An object of the present invention is to improve performance of a specialization-based ensemble scheme by solving the overconfident issue of a deep learning model. The specialization-based ensemble scheme shows high performance with respect to specialized data, but has a problem in that to select a model generating a correct solution is obscure due to the overconfident issue. In order to solve the problem, there is proposed a scheme capable of generating more general features by sharing a new form of a loss function that forces not-specialized data to have a uniform distribution and features between models.

In accordance with the embodiments of the present invention, more general features can be generated and performance can be improved by sharing a new loss function for specializing each model for a specific sub-task while having confidence and features between the models using the ensemble scheme which can be applied to various situations, such as image classification and image segmentation.

The apparatus described above may be implemented in the form of a combination of hardware components, software components and/or hardware components and software components. For example, the apparatus and components described in the embodiments may be implemented using one or more general-purpose computers or special-purpose computers, for example, a processor, a controller, an arithmetic logic unit (ALU), a digital signal processor, a microcomputer, a field programmable array (FPA), a programmable logic unit (PLU), a microprocessor or any other device capable of executing or responding to an instruction. A processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may be aware that the processing device may include a plurality of processing elements and/or a plurality of types of processing elements. For example, the processing device may include a plurality of processors or a single processor and a single controller. Furthermore, other processing configuration, such as a parallel processor, is also possible.

Software may include a computer program, code, an instruction or one or more combinations of them and may configure the processing device so that it operates as desired or may instruct the processing device independently or collectively. Software and/or data may be interpreted by the processing device or may be embodied in a machine, component, physical device, virtual equipment or computer storage medium or device of any type or a transmitted signal wave permanently or temporarily in order to provide an instruction or data to the processing device. Software may be distributed to computer systems connected over a network and may be stored or executed in a distributed manner. Software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure solely or in combination. The program instruction recorded on the recording medium may have been specially designed and configured for the embodiment or may be known to those skilled in computer software. The computer-readable recording medium includes a hardware device specially configured to store and execute the program instruction, for example, magnetic media such as a hard disk, a floppy disk, and a magnetic tape, optical media such as CD-ROM or a DVD, magneto-optical media such as a floptical disk, ROM, RAM, or flash memory. Examples of the program instruction may include both machine-language code, such as code written by a compiler, and high-level language code executable by a computer using an interpreter. The hardware device may be configured in the form of one or more software modules for executing the operation of the embodiment, and the vice versa.

Although the present invention has been described in connection with the limited embodiments and the drawings, the present invention is not limited to the embodiments. A person having ordinary skill in the art to which the present invention pertains can substitute, modify, and change the present invention without departing from the technological spirit of the present invention from the description.

Accordingly, the range of right of the present invention should not be limited to the aforementioned embodiments, but should be defined by the claims and equivalent thereof.

What is claimed is:

1. An ensemble method, comprising steps of:
generating a target function of maximizing entropy by minimizing Kullback-Leibler divergence with a uniform distribution with respect to the not-classified data of models for image processing; and
generating general features by sharing features between the models and performing learning for image processing using the general features.

2. The ensemble method of claim 1, wherein the step of generating the target function of maximizing entropy by minimizing the Kullback-Leibler divergence with the uniform distribution with respect to the not-classified data of models for image processing comprises learning an existing loss for corresponding data with respect to only one model having highest accuracy and minimizing the Kullback-Leibler divergence with respect to remaining models.

3. The ensemble method of claim 1, wherein the step of generating the target function of maximizing entropy by minimizing the Kullback-Leibler divergence with the uniform distribution with respect to the not-classified data of models for image processing comprises steps of:
selecting a random batch based on a stochastic gradient descent;
calculating a target function value for each model with respect to the selected random batch;
calculating a gradient for a learning loss with respect to a model having a smallest target function value for each datum and updating model parameters; and
calculating a gradient for the Kullback-Leibler divergence with respect to remaining models other than the model having the smallest target function value and updating the model parameters.

4. The ensemble method of claim 3, wherein the step of calculating the target function value for each model with respect to the selected random batch comprises calculating the target function value using an equation below.
$${L}_{C} ( 𝒟 ) = {min}_{{v}_{i}^{m}} {\sum }_{i = 1}^{N} {\sum }_{m = 1}^{M} ( {v}_{i}^{m} l ( {y}_{i} , {P}_{{θ}_{m}} ( y \vert {x}_{i} ) ) + β ( 1 - {v}_{i}^{m} ) {D}_{KL} ( u ( y ) \vert \vert {P}_{{θ}_{m}} ( y \vert {x}_{i} ) ) )$$
$$wherein$$
$${\sum }_{m = 1}^{M} {v}_{i}^{m} = 1$$
and vᵢ^{m}∈{0,1}, P_{θ}_{ₘ}(y|x) indicates a prediction value of an m-th model with respect to input x, D_{KL} indicates the Kullback-Leibler divergence, U(y) indicates the uniform distribution, β indicates a penalty parameter and vᵢ^{m} indicates an assignment parameter.

5. The ensemble method of claim 1, wherein the step of generating the general features by sharing the feature between the models and performing the learning for image processing using the general features comprises calculating the general features using an equation below.
$${h}_{m}^{l} ( x ) = φ ( {w}_{m}^{l} ( {h}_{m}^{l - 1} ( x ) + {\sum }_{n \neq m} {σ}_{nm}^{l} * {h}_{n}^{l - 1} ( x ) ) )$$
wherein W indicates weight of a neural network, h indicates a hidden feature, a indicates σ Bernoulli random feature, and ϕ indicates an activation function.

6. An ensemble apparatus, comprising:
a target function calculation unit configured to calculate a target function of maximizing entropy by minimizing Kullback-Leibler divergence with a uniform distribution with respect to not-classified data of models for image processing; and
a feature sharing unit configured to generate general features by sharing features between the models and to perform learning for image processing using the general features.

7. The ensemble apparatus of claim 6, wherein the target function calculation unit learns an existing loss for corresponding data with respect to only one model having highest accuracy and minimizes the Kullback-Leibler divergence with respect to remaining models.

8. The ensemble apparatus of claim 6, wherein the target function calculation unit comprises:
a random batch choice unit configured to select a random batch based on a stochastic gradient descent;
a calculation unit configured to calculate a target function value for each model with respect to the selected random batch; and
an update unit configured to calculate a gradient for a learning loss with respect to a model having a smallest target function value for each datum and update model parameters and to calculate a gradient for Kullback-Leibler divergence with respect to remaining models other than the model having the smallest target function value and update model parameters.

9. The ensemble apparatus of claim 8, wherein the calculation unit calculates the target function value using an equation below.
$${L}_{C} ( 𝒟 ) = {min}_{{v}_{i}^{m}} {\sum }_{i = 1}^{N} {\sum }_{m = 1}^{M} ( {v}_{i}^{m} l ( {y}_{i} , {P}_{{θ}_{m}} ( y \vert {x}_{i} ) ) + β ( 1 - {v}_{i}^{m} ) {D}_{KL} ( u ( y ) \vert \vert {P}_{{θ}_{m}} ( y \vert {x}_{i} ) ) )$$
$$wherein$$
$${\sum }_{m = 1}^{M} {v}_{i}^{m} = 1$$
and vᵢ^{m}∈{0,1}, P_{θ}_{ₘ}(y|x) indicates a prediction value of an m-th model with respect to input x, D_{KL} indicates the Kullback-Leibler divergence, U(y) indicates the uniform distribution, β indicates a penalty parameter and vᵢ^{m} indicates an assignment parameter.

10. The ensemble apparatus of claim 6, wherein the feature sharing unit calculates the general features using an equation below.
$${h}_{m}^{l} ( x ) = φ ( {w}_{m}^{l} ( {h}_{m}^{l - 1} ( x ) + {\sum }_{n \neq m} {σ}_{nm}^{l} * {h}_{n}^{l - 1} ( x ) ) )$$
wherein W indicates weight of a neural network, h indicates a hidden feature, a indicates σ Bernoulli random feature, and θ indicates an activation function.
